(19) United States
(12) Patent Application Publication
(10) Pub. No.: US 2021/0199617 A1
(43) Pub. Date: Jul. 1, 2021

(54) SENSOR ELEMENT FOR GAS SENSOR

(71) Applicant: NGK INSULATORS, LTD., Nagoya-shi (JP)

(72) Inventor: Ryo ONISHI, Iwakura-shi (JP)

(21) Appl. No.: 17/117,165

(22) Filed: Dec. 10, 2020

(30) Foreign Application Priority Data
Dec. 26, 2019 (JP) 2019-237014

(51) Int. Cl. G01N 27/407; G01N 27/406

(52) U.S. Cl. CPC G01N 27/4077; G01N 27/4071; G01N 27/4067

(57) ABSTRACT

A sensor element for a gas sensor includes: an element base being a ceramic structure and including a sensing part for sensing a gas component to be measured and a heater for heating the sensor element; and a leading-end protective layer disposed around an outer periphery of the element base in a predetermined range at least including a leading end surface, and being a porous layer including one or more unit layers, wherein a radius of curvature of the leading-end protective layer on a side of the leading end surface in vertical cross section along a longitudinal direction of the sensor element is greater than ½ of thickness of the element base and is 3 mm or less.

### CROSS-REFERENCE TO RELATED APPLICATION

The present application claims priority from Japanese application JP2019-237014, filed on Dec. 26, 2019, the contents of which is hereby incorporated by reference into this application.

### BACKGROUND OF THE INVENTION

### Field of the Invention

The present invention relates to a sensor element for a gas sensor, and, in particular, to a surface protective layer thereof.

### Description of the Background Art

As a gas sensor for determining concentration of a desired gas component contained in a measurement gas, such as an exhaust gas from an internal combustion engine, a gas sensor that includes a sensor element made of an oxygen-ion conductive solid electrolyte, such as zirconia (ZrO₂), and including some electrodes on the surface and the inside thereof has been widely known. As the sensor element, a sensor element having an elongated planar shape and comprising a protective layer formed of a porous body (porous protective layer) in an end portion in which a part for introducing the measurement gas is provided has been known (see Japanese Patent Application Laid-Open No. 2016-65852, for example).

In a sensor element as disclosed in Japanese Patent Application Laid-Open No. 2016-65852, the concentration of the desired gas component is specified based on a current flowing through the solid electrolyte when the measurement gas having been introduced through a gas inlet into an internal chamber is pumped by an electrochemical pump cell.

The protective layer is provided to the surface of such a sensor element to secure water resistance of the sensor element when the gas sensor is in use. Specifically, the protective layer is provided to prevent, in a case where water droplets adhere to the surface of the sensor element in a state of being heated by a heater located inside the sensor element, water-induced cracking of the sensor element under the action of thermal shock caused by heat (cold) from the water droplets on the sensor element.

In a case of an elongated planar sensor element as disclosed in Japanese Patent Application Laid-Open No. 2016-65852, most of the surface thereof is two main surfaces opposing each other, and thus securing of water resistance using the protective layer has mainly been performed by devising the location, the shape, the composition, the configuration, and the like of the protective layer on the main surfaces. On the other hand, it is also important to secure water resistance of a leading end portion of the element in which the gas inlet is provided, but water resistance of the leading end portion of the conventional sensor element has not necessarily sufficiently been studied.

The inventor of the present invention has found the shape of the protective layer contributing to improvement in water resistance of the leading end portion from intensive studies on the relationship between the shape of the leading end portion of the protective layer and water resistance.

### SUMMARY

The present invention relates to a sensor element for a gas sensor, and, in particular, to a configuration of a surface protective layer thereof.

According to the present invention, a sensor element for a gas sensor includes: an element base being a ceramic structure, the element base including a sensing part for sensing a gas component to be measured and a heater for heating the sensor element; and a leading-end protective layer disposed around an outer periphery of the element base in a predetermined range at least including a leading end surface, and being a porous layer including one or more unit layers, wherein a radius of curvature of the leading-end protective layer on a side of the leading end surface in vertical cross section along a longitudinal direction of the sensor element is greater than ½ of thickness of the element base and is 3 mm or less.

The sensor element for the gas sensor having good water resistance in a leading end portion is thereby achieved.

It is thus an object of the present invention to provide a sensor element including a protective layer having excellent water resistance in a leading end portion.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic external perspective view of a sensor element 10;

FIG. 2 is a schematic view of a configuration of a gas sensor 100 including a vertical cross-sectional view taken along a longitudinal direction of the sensor element 10;

FIG. 3 is a schematic view of a cross section of the sensor element 10 on a side of one end portion E1;

FIG. 4 illustrates a main shape variation of a leading end portion 2e of a leading-end protective layer 2;

FIG. 5 illustrates another main shape variation of the leading end portion 2e of the leading-end protective layer 2;

FIG. 6 illustrates yet another main shape variation of the leading end portion 2e of the leading-end protective layer 2;

FIG. 7 is a schematic view of a cross section of the sensor element 10 on the side of the one end portion E1 in a case where the leading-end protective layer 2 has a two-layer configuration of an inner leading-end protective layer 2a and an outer leading-end protective layer 2b;

FIG. 8 is a flowchart of processing at the manufacture of the sensor element 10; and

FIG. 9 is a plot of a value of water resistance of the leading end portion 2e against a radius of curvature of the leading end portion 2e.

### DESCRIPTION OF THE PREFERRED EMBODIMENTS

<Overview of Sensor Element and Gas Sensor>

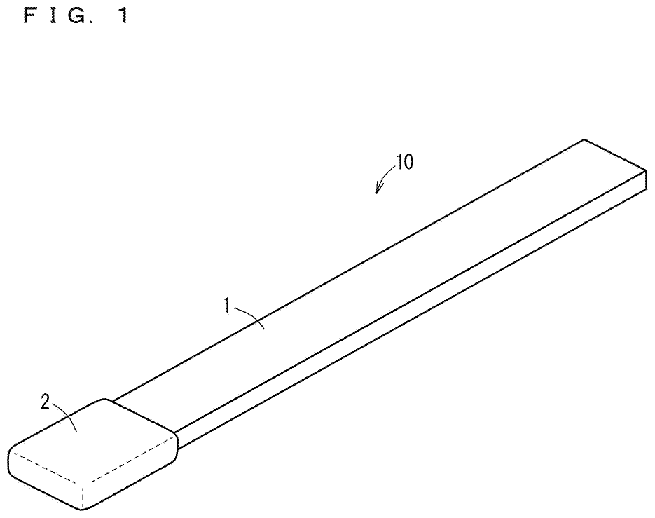

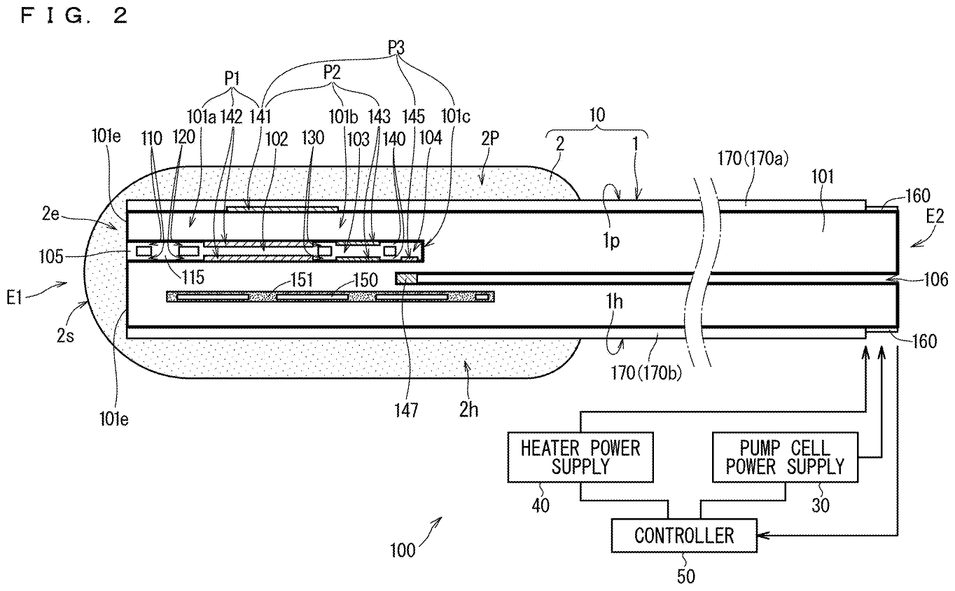

FIG. 1 is a schematic external perspective view of a sensor element (gas sensor element) 10 according to an embodiment of the present invention. FIG. 2 is a schematic view of a configuration of a gas sensor 100 including a vertical cross-sectional view (a cross-sectional view in a direction of the thickness) taken along a longitudinal direction of the sensor element 10. The sensor element 10 is a ceramic structure as a main component of the gas sensor 100 sensing a predetermined gas component in a measurement gas, and measuring concentration thereof. The sensor element 10 is a so-called limiting current gas sensor element.

In addition to the sensor element 10, the gas sensor 100 mainly includes a pump cell power supply 30, a heater power supply 40, and a controller 50.

As illustrated in FIG. 1, the sensor element 10 has a configuration in which one end portion of an elongated planar element base 1 is covered with a porous leading-end protective layer 2.

As illustrated in FIG. 2, the element base 1 includes an elongated planar ceramic body 101 as a main structure, main-surface protective layers 170 are provided on two main surfaces of the ceramic body 101, and, in the sensor element 10, the leading-end protective layer 2 is further provided outside both an end surface (a leading end surface 101e of the ceramic body 101) and four side surfaces on a side of one leading end portion. The four side surfaces other than opposite end surfaces in the longitudinal direction of the sensor element 10 (or the element base 1, or the ceramic body 101) are hereinafter simply referred to as side surfaces of the sensor element 10 (or the element base 1, or the ceramic body 101).

The ceramic body 101 is made of ceramic containing, as a main component, zirconia (yttrium stabilized zirconia), which is an oxygen-ion conductive solid electrolyte. Various components of the sensor element 10 are provided outside and inside the ceramic body 101. The ceramic body 101 having the configuration is dense and airtight. The configuration of the sensor element 10 illustrated in FIG. 2 is just an example, and a specific configuration of the sensor element 10 is not limited to this configuration.

The sensor element 10 illustrated in FIG. 2 is a so-called serial three-chamber structure type gas sensor element including a first internal chamber 102, a second internal chamber 103, and a third internal chamber 104 inside the ceramic body 101. That is to say, in the sensor element 10, the first internal chamber 102 communicates, through a first diffusion control part 110 and a second diffusion control part 120, with a gas inlet 105 opening to the outside on a side of one end portion E1 of the ceramic body 101 (the element base 1) (to be precise, communicating with the outside through the leading-end protective layer 2), the second internal chamber 103 communicates with the first internal chamber 102 through a third diffusion control part 130, and the third internal chamber 104 communicates with the second internal chamber 103 through a fourth diffusion control part 140. A path from the gas inlet 105 to the third internal chamber 104 is also referred to as a gas distribution part. In the sensor element 10 according to the present embodiment, the distribution part is provided straight along the longitudinal direction of the ceramic body 101.

The first diffusion control part 110, the second diffusion control part 120, the third diffusion control part 130, and the fourth diffusion control part 140 are each provided as two slits vertically arranged in FIG. 2. The first diffusion control part 110, the second diffusion control part 120, the third diffusion control part 130, and the fourth diffusion control part 140 provide predetermined diffusion resistance to the measurement gas passing therethrough. A buffer space 115 having an effect of buffering pulsation of the measurement gas is provided between the first diffusion control part 110 and the second diffusion control part 120.

An outer pump electrode 141 is provided on an outer surface of the ceramic body 101, and an inner pump electrode 142 is provided in the first internal chamber 102. Furthermore, an auxiliary pump electrode 143 is provided in the second internal chamber 103, and a measurement electrode 145 as a sensing part for directly sensing a gas component to be measured is provided in the third internal chamber 104. In addition, a reference gas inlet 106 which communicates with the outside and through which a reference gas is introduced is provided on a side of the other end portion E2 of the ceramic body 101, and a reference electrode 147 is provided in the reference gas inlet 106.

In a case where a target of measurement of the sensor element 10 is NOx in the measurement gas, for example, concentration of a NOx gas in the measurement gas is calculated by a process as described below.

First, the measurement gas introduced into the first internal chamber 102 is adjusted to have a substantially constant oxygen concentration by a pumping action (pumping in or out of oxygen) of a main pump cell P1, and then introduced into the second internal chamber 103. The main pump cell P1 is an electrochemical pump cell including the outer pump electrode 141, the inner pump electrode 142, and a ceramic layer 101a that is a portion of the ceramic body 101 existing between these electrodes. In the second internal chamber 103, oxygen in the measurement gas is pumped out of the element by a pumping action of an auxiliary pump cell P2 that is also an electrochemical pump cell, so that the measurement gas is in a sufficiently low oxygen partial pressure state. The auxiliary pump cell P2 includes the outer pump electrode 141, the auxiliary pump electrode 143, and a ceramic layer 101b that is a portion of the ceramic body 101 existing between these electrodes.

The outer pump electrode 141, the inner pump electrode 142, and the auxiliary pump electrode 143 are each formed as a porous cermet electrode (e.g., a cermet electrode made of ZrO₂ and Pt that contains Au of 1%). The inner pump electrode 142 and the auxiliary pump electrode 143 to be in contact with the measurement gas are each formed using a material having weakened or no reducing ability with respect to a NOx component in the measurement gas.

NOx in the measurement gas caused by the auxiliary pump cell P2 to be in the low oxygen partial pressure state is introduced into the third internal chamber 104, and reduced or decomposed by the measurement electrode 145 provided in the third internal chamber 104. The measurement electrode 145 is a porous cermet electrode also functioning as a NOx reduction catalyst that reduces NOx existing in an atmosphere in the third internal chamber 104. During the reduction or decomposition, a potential difference between the measurement electrode 145 and the reference electrode 147 is maintained constant. Oxygen ions generated by the above-mentioned reduction or decomposition are pumped out of the element by a measurement pump cell P3. The measurement pump cell P3 includes the outer pump electrode 141, the measurement electrode 145, and a ceramic layer 101c that is a portion of the ceramic body 101 existing between these electrodes. The measurement pump cell P3 is an electrochemical pump cell pumping out oxygen generated by decomposition of NOx in an atmosphere around the measurement electrode 145.

Pumping (pumping in or out of oxygen) of the main pump cell P1, the auxiliary pump cell P2, and the measurement pump cell P3 is achieved, under control performed by the controller 50, by the pump cell power supply (variable power supply) 30 applying a voltage necessary for pumping across electrodes included in each of the pump cells. In a case of the measurement pump cell P3, a voltage is applied across the outer pump electrode 141 and the measurement electrode 145 so that the potential difference between the measurement electrode 145 and the reference electrode 147 is maintained at a predetermined value. The pump cell power supply 30 is typically provided for each pump cell.

The controller 50 detects a pump current Ip2 flowing between the measurement electrode 145 and the outer pump electrode 141 in accordance with the amount of oxygen pumped out by the measurement pump cell P3, and calculates a NOx concentration in the measurement gas based on a linear relationship between a current value (NOx signal) of the pump current Ip2 and the concentration of decomposed NOx.

The gas sensor 100 preferably includes a plurality of electrochemical sensor cells, which are not illustrated, sensing the potential difference between each pump electrode and the reference electrode 147, and each pump cell is controlled by the controller 50 based on a signal detected by each sensor cell.

In the sensor element 10, a heater 150 is buried in the ceramic body 101. The heater 150 is provided, below the gas distribution part in FIG. 2, over a range from the vicinity of the one end portion E1 to at least a location of formation of the measurement electrode 145 and the reference electrode 147. The heater 150 is provided mainly to heat the sensor element 10 to enhance oxygen-ion conductivity of the solid electrolyte forming the ceramic body 101 when the sensor element 10 is in use. More particularly, the heater 150 is provided to be surrounded by an insulating layer 151.

The heater 150 is a resistance heating body made, for example, of platinum. The heater 150 generates heat by being powered from the heater power supply 40 under control performed by the controller 50.

The sensor element 10 according to the present embodiment is heated by the heater 150 when being in use so that the temperature at least in a range from the first internal chamber 102 to the second internal chamber 103 becomes 500° C. or more. In some cases, the sensor element 10 is heated so that the temperature of the gas distribution part as a whole from the gas inlet 105 to the third internal chamber 104 becomes 500° C. or more. These are to enhance the oxygen-ion conductivity of the solid electrolyte forming each pump cell and to desirably demonstrate the ability of each pump cell. In this case, the temperature in the vicinity of the first internal chamber 102, which becomes the highest temperature, becomes approximately 700° C. to 800° C.

In the following description, from among the two main surfaces of the element base 1 (the ceramic body 101), a main surface (or an outer surface of the sensor element 10 having the main surface) which is located on an upper side in FIG. 2 and on a side where the main pump cell P1, the auxiliary pump cell P2, and the measurement pump cell P3 are mainly provided is referred to as a pump surface 1p, and a main surface (or an outer surface of the sensor element 10 having the main surface) which is located on a lower side in FIG. 2 and on a side where the heater 150 is provided is referred to as a heater surface 1h. In other words, the pump surface 1p is a main surface closer to the gas inlet 105, the three internal chambers, and the pump cells than to the heater 150, and the heater surface 1h is a main surface closer to the heater 150 than to the gas inlet 105, the three internal chambers, and the pump cells.

A plurality of electrode terminals 160 are formed on the respective main surfaces of the ceramic body 101 on the side of the other end portion E2 to establish electrical connection between the sensor element 10 and the outside. These electrode terminals 160 are electrically connected to the above-mentioned five electrodes, opposite ends of the heater 150, and a lead for detecting heater resistance, which is not illustrated, through leads provided inside the ceramic body 101, which are not illustrated, to have a predetermined correspondence relationship. Application of a voltage from the pump cell power supply 30 to each pump cell of the sensor element 10 and heating by the heater 150 by being powered from the heater power supply 40 are thus performed through the electrode terminals 160.

The sensor element 10 further includes the above-mentioned main-surface protective layers 170 (170a and 170b) on the pump surface 1p and the heater surface 1h of the ceramic body 101. The main-surface protective layers 170 are layers made of alumina, having a thickness of approximately 5 μm to 30 μm, and including pores with a porosity of approximately 20% to 40%, and are provided to prevent adherence of any foreign matter and poisoning substances to the main surfaces (the pump surface 1p and the heater surface 1h) of the ceramic body 101 and the outer pump electrode 141 provided on a side of the pump surface 1p. The main-surface protective layer 170a on the side of the pump surface 1p thus functions as a pump electrode protective layer for protecting the outer pump electrode 141.

In the present embodiment, the porosity is obtained by applying a known image processing method (e.g., binarization processing) to a scanning electron microscope (SEM) image of an evaluation target.

The main-surface protective layers 170 are provided over substantially all of the pump surface 1p and the heater surface 1h except that the electrode terminals 160 are partially exposed in FIG. 2, but this is just an example. The main-surface protective layers 170 may locally be provided in the vicinity of the outer pump electrode 141 on the side of the one end portion E1 compared with the case illustrated in FIG. 2.

<Leading-End Protective Layer>

In the sensor element 10, the leading-end protective layer 2 is provided around an outermost periphery of the element base 1 having a configuration as described above in a predetermined range from the one end portion E1.

The leading-end protective layer 2 is provided in a manner of surrounding a portion of the element base 1 in which the temperature becomes high (up to approximately 700° C. to 800° C.) when the gas sensor 100 is in use, in order to secure water resistance of the portion to thereby suppress the occurrence of cracking (water-induced cracking) of the element base 1 due to thermal shock caused by local temperature reduction upon direct contact of the portion with water.

In the present embodiment, as a result of repeating dropping of a predetermined amount of water onto the leading-end protective layer 2 until any abnormality of a pump current Ip0 occurs before and after dropping, a maximum amount of dropped water not causing the abnormality of the pump current Ip0 is defined as a critical water amount. Whether water resistance is good or not is determined based on the magnitude of a value of the critical water amount. In this case, the term “water resistance” can be used in the sense of the critical water amount.

In addition, the leading-end protective layer 2 is provided to secure poisoning resistance to prevent poisoning substances, such as Mg, from entering into the sensor element 10.

The leading-end protective layer 2 is provided to cover the leading end surface 101e and the four side surfaces of the element base 1 on the side of the one end portion E1 (around an outer periphery of the element base 1 on the side of the one end portion E1). A portion of the leading-end protective layer 2 on a side of the leading end surface 101e is particularly referred to as a leading end portion 2e, a portion of the leading-end protective layer 2 on the side of the pump surface 1p is particularly referred to as a pump surface portion 2p, and a portion of the leading-end protective layer 2 on a side of the heater surface 1h is particularly referred to as a heater surface portion 2h.

In a case of a configuration illustrated in FIG. 2, the leading-end protective layer 2 is made of alumina to have a porosity of 15% or more and 30% or less. The leading-end protective layer 2 is provided as a low thermal conductivity layer having a great porosity to have a function to suppress thermal conduction from the outside to the element base 1.

The leading-end protective layer 2 is formed by sequentially thermal spraying (plasma-spraying) a material therefor onto the element base 1. This is to develop an anchoring effect between the element base 1 and the leading-end protective layer 2 to thereby secure bonding (adhesion) of the leading-end protective layer 2 to the element base 1.

The leading-end protective layer 2 is provided to be substantially flat in the pump surface portion 2p and the heater surface portion 2h, but, in the leading end portion 2e, is provided to be convex as a whole and have a curved outer peripheral surface 2s. More specifically, the leading-end protective layer 2 is provided so that, at least within a range of the width of the element base 1 in the leading end portion 2e, the outer peripheral surface 2s is convexly curved toward the outside of the sensor element 10 in vertical cross section along the longitudinal direction of the element as illustrated in FIG. 2. The vertical cross section along the longitudinal direction of the sensor element 10 is hereinafter simply referred to as a cross section, and the shape of the cross section is hereinafter simply referred to as a cross-sectional shape unless otherwise noted.

In the present embodiment, a radius of curvature in cross section (hereinafter, cross-sectional radius of curvature) of the outer peripheral surface 2s is used as an index characterizing the shape of the leading end portion 2e of the leading-end protective layer 2.

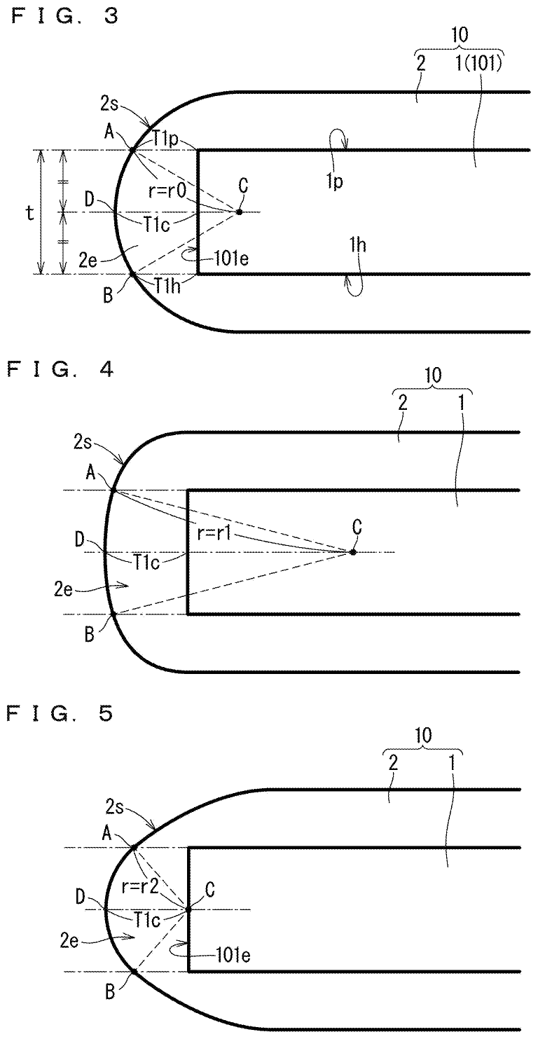

FIG. 3 is a schematic view of a cross section of the sensor element 10 on the side of the one end portion E1 illustrated to describe a manner of specifying the cross-sectional radius of curvature of the outer peripheral surface 2s.

In specifying the cross-sectional radius of curvature, two intersections are specified first, which are intersections of a curve representing the cross section (hereinafter, cross-sectional curve) in the leading end portion 2e of the leading-end protective layer 2 with straight lines representing cross sections of imaginary planes obtained by extending the pump surface 1p and the heater surface 1h of the element base 1 toward the leading end portion 2e. The two intersections are shown as points A and B in FIG. 3. Assuming that the cross-sectional curve connecting the points A and B is an arc AB, a radius of the arc AB (a radius of a circle including the arc AB as a part of its circumference) is the cross-sectional radius of curvature r. In a case illustrated in FIG. 3, a point C represents the center of the arc AB, and line segments CA and CB are each the cross-sectional radius of curvature r.

A value of the cross-sectional radius of curvature r in the leading end portion 2e in the configuration illustrated in FIG. 3 is hereinafter defined as r0.

Various methods are applicable as a method of calculating the cross-sectional radius of curvature r. For example, a known curve fitting method may be applied to numerically calculate the cross-sectional radius of curvature r.

Alternatively, the cross-sectional radius of curvature r may analytically (geometrically) be obtained using specification of another point on the cross-sectional curve in addition to the points A and B allowing for unique determination of an arc passing through the three points.

To take a relatively simple example, as illustrated in FIG. 3, assuming that the leading end portion 2e of the leading-end protective layer 2 has a maximum thickness (distance from the leading end surface 101e) in a middle portion thereof in the direction of the thickness of the element, more specifically, assuming that the leading end portion 2e has the maximum thickness at a point D as an intersection of an imaginary plane passing through the point C as the center of the arc AB and being parallel to the pump surface 1p and the hater surface 1h with the cross-sectional curve, and the arc AB is symmetrical with respect to the plane passing though the points C and D, the following equation is satisfied from the Pythagorean theorem, where t is the thickness of the element base 1, T1c is the maximum thickness of the leading end portion 2e of the leading-end protective layer 2, T1p is the thickness at the point A, T1h is the thickness at the point B, and besides, T1p=T1h.

r={(t/2)²+(T1c−T1p)²}/2(T1c−T1p) (1)

FIGS. 4 to 6 illustrate main shape variations of the leading end portion 2e of the leading-end protective layer 2. As in FIG. 3, the variations are based on the assumption that the arc AB is symmetrical with respect to the plane passing through the points C and D, and the leading end portion 2e of the leading-end protective layer 2 has the maximum thickness (distance from the leading end surface 101e) at the point D.

The leading end portion 2e can have various different shapes in accordance with the value of the cross-sectional radius of curvature r.

FIG. 4 illustrates a case where the cross-sectional shape of the leading end portion 2e is flatter than that of the leading end portion 2e of the sensor element 10 illustrated in FIG. 3. In this case, the cross-sectional radius of curvature r has a value (r1 in FIG. 4) greater than r0 even if the maximum thickness T1c of the leading end portion 2e of the leading-end protective layer 2 is similar to that in the case illustrated in FIG. 3. If the maximum thickness T1c is the same, the center C is located farther from the leading end surface 101e as the cross-sectional radius of curvature r increases.

FIG. 5 illustrates a case where the cross-sectional shape of the leading end portion 2e is sharper than that of the leading end portion 2e of the sensor element 10 illustrated in FIG. 3. In this case, the cross-sectional radius of curvature r has a value (r2 in FIG. 5) smaller than r0 even if the maximum thickness T1c of the leading end portion 2e of the leading-end protective layer 2 is similar to that in the case illustrated in FIG. 3. If the maximum thickness T1c is the same, the center C is located closer to the leading end surface 101e as the cross-sectional radius of curvature r decreases. A case where the center C is located on the leading end surface 101e is illustrated, in particular, in FIG. 5.

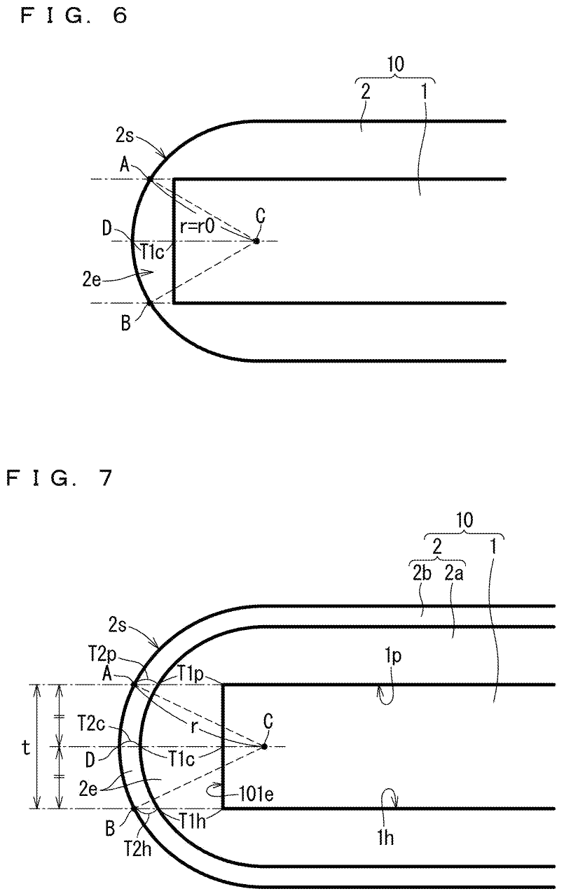

On the other hand, FIG. 6 illustrates a case where the leading end portion 2e of the leading-end protective layer 2 has a different thickness while the value of the cross-sectional radius of curvature r is r0, which is the same as that in the case illustrated in FIG. 3. More specifically, a case where the maximum thickness T1c is smaller than that in the case illustrated in FIG. 3 is illustrated. As illustrated in FIG. 6, the cross-sectional shape of the leading end portion 2e is the same as that of the sensor element 10 illustrated in FIG. 3 if the cross-sectional radius of curvature r is the same.

The inventor of the present invention has found, from intensive studies, that water resistance of the sensor element 10 tends to be improved when the cross-sectional radius of curvature r of the leading end portion 2e has a smaller value, that is, the leading end portion 2e has a sharper cross-sectional shape. From among the sensor elements 10 illustrated in FIGS. 3, 4, and 5, for example, the sensor element 10 illustrated in FIG. 5 has the cross-sectional shape having the best water resistance, followed by the sensor element 10 illustrated in FIG. 3 and then the sensor element 10 illustrated in FIG. 4.

Specifically, good water resistance of the leading end portion 2e (leading end water resistance) is secured when the cross-sectional radius of curvature r has a value of 3 mm or less. Specifically, leading end water resistance of more than 10 μL can be obtained.

Note that r>t/2. A case where r<t/2 is not preferable because a corner formed by the leading end surface 101e and the pump surface 1p and a corner formed by the leading end surface 101e and the heater surface 1h are not covered with the leading-end protective layer 2. The element base 1 usually has a thickness t of approximately 1 mm to 1.5 mm, so that a realistic lower limit of the cross-sectional radius of curvature r is approximately 0.5 mm.

It is believed that the leading end portion 2e has good leading end water resistance when having a value of the cross-sectional radius of curvature r of 3 mm or less as described above, because the leading end portion 2e has a shape allowing water droplets coming from the outside and adhering to the leading end portion 2e to easily flow without being accumulated at the location. That is to say, once water droplets adhere to and further are accumulated on the surface of the leading-end protective layer 2 heated to a high temperature when the sensor element 10 is in use (e.g., when the sensor element 10 is attached to an exhaust pipe of an internal combustion engine, and used), heat absorption occurs noticeably at the location, and can cause water-induced cracking. However, it is believed that, even when the water droplets momentarily adhere, the heat absorption does not noticeably occur at the location of adherence if the water droplets are not accumulated, to thereby make the water-induced cracking less likely to occur.

The cross-sectional radius of curvature r more preferably has a value of 2 mm or less. In this case, extremely good leading end water resistance is secured. Specifically, leading end water resistance of more than 30 μL can be obtained.

The maximum thickness T1c of the leading end portion 2e is preferably 400 μm to 800 μm. When the maximum thickness T1c is less than 400 μm, strength may not sufficiently be secured. The maximum thickness T1c exceeding 800 μm is not preferable because it makes it difficult for the measurement gas to reach the gas inlet 105, and can cause reduction in responsiveness.

As long as the leading end portion 2e is provided to be convex as a whole as described above, the cross-sectional radius of curvature and the thickness may vary in a direction of the width of the element. For example, the middle portion in the direction of the width of the element may have a minimum cross-sectional radius of curvature or a maximum thickness, and the cross-sectional radius of curvature may increase or the thickness may decrease with decreasing distance from side portions.

<Case where Leading-End Protective Layer has Laminated Structure>

While FIGS. 2 to 6 each illustrate the sensor element 10 including the leading-end protective layer 2 as a single layer, the leading-end protective layer 2 may have a laminated structure in which two or more layers (unit layers) are laminated.

In a case where the leading-end protective layer 2 has the laminated structure as described above, the points A and B (and further the points C and D) can be considered in cross section of the sensor element 10 as in a case illustrated in FIG. 3. In a case where the cross-sectional radius of curvature r of the outer peripheral surface 2s specified based on these points is 3 mm or less, good water resistance (leading end water resistance) of the leading end portion 2e is secured.

As an example of the case, FIG. 7 is a schematic view of the cross section of the sensor element 10 on the side of the one end portion E1 in a case where the leading-end protective layer 2 has a two-layer configuration of an inner leading-end protective layer 2a and an outer leading-end protective layer 2b.

Assume that the inner leading-end protective layer 2a is made of alumina to have a greater porosity than the outer leading-end protective layer 2b of 30% or more and 80% or less. In contrast, assume that the outer leading-end protective layer 2b is made of alumina to have a porosity of 15% or more and 30 or less as with the leading-end protective layer 2 of the sensor element 10 illustrated in FIG. 2. The leading-end protective layer 2 illustrated in FIG. 7 thus has reduced thermal conductivity while securing a total thickness. In this case, however, the maximum thickness of the leading end portion 2e is preferably 400 μm to 800 μm as in the case of the single layer.

On the other hand, the cross-sectional radius of curvature r of the outer peripheral surface 2s of the leading end portion 2e is 3 mm or less in a range in which r>t/2 is satisfied as in the case of the single layer illustrated in FIG. 3. The leading-end protective layer 2 illustrated in FIG. 7 thus has water resistance similar to that in the case of the single layer illustrated in FIG. 3.

That is to say, the leading-end protective layer 2 illustrated in FIG. 7 is provided so that the outer peripheral surface 2s has a cross-sectional shape having the cross-sectional radius of curvature r of 3 mm or less, and, further, the inner leading-end protective layer 2a provided inside the leading-end protective layer 2 has a great porosity to thereby have low thermal conductivity, in order to secure the total thickness and reduce thermal conductivity. As a result, the leading-end protective layer 2 having the two-layer configuration illustrated in FIG. 7 has better leading end water resistance than that in the case of the single layer.

The cross-sectional radius of curvature r more preferably has a value of 2 mm or less. In this case, extremely good leading end water resistance is secured. Specifically, leading end water resistance of more than 30 μL can be obtained.

In this case, the inner leading-end protective layer 2a and the outer leading-end protective layer 2b are each formed by sequentially thermal spraying (plasma-spraying) a material therefor.

FIG. 7 illustrates a configuration in which the outer leading-end protective layer 2b is provided to have substantially the same thickness on the inner leading-end protective layer 2a having a curved outermost surface in the leading end portion 2e, so that the outer peripheral surface 2s of the leading-end protective layer 2 to be an outermost surface of the outer leading-end protective layer 2b has a curve in the leading end portion 2e. However, this is just an example, and an actual form of each of the layers is not limited to that in this example. The layers may have different forms as long as the outermost surface of the outer leading-end protective layer 2b to be the outer peripheral surface 2s of the leading-end protective layer 2 as a whole has a cross-sectional radius of curvature r of 3 mm or less.

As in the case illustrated in FIG. 3, in FIG. 7, assuming that the leading end portion 2e of the leading-end protective layer 2 has the maximum thickness at the point D as the intersection of the imaginary plane passing through the point C as the center of the arc AB and being parallel to the pump surface 1p and the hater surface 1h with the cross-sectional curve, and the arc AB is symmetrical with respect to the plane passing though the points C and D, the cross-sectional radius of curvature r satisfies the following equation.

r=[(t/2)²+{(T1c+T2c)−(T1p+T2p)}²]/2{(T1c+T2c)−(T1p+T2p)} (2)

In the equation (2), however, the total thickness at the point D at which the leading end portion 2e of the leading-end protective layer 2 has the maximum thickness is expressed as T1c+T2c (T1c is the thickness of the inner leading-end protective layer 2a and T2c is the thickness of the outer leading-end protective layer 2b) based on FIG. 7. Similarly, the thickness at the point A is expressed as T1p+T2p, and the thickness at the point B is expressed as T1h+T2h. Note that T1p+T2p=T1h+T2h.

As described above, in the sensor element according to the present embodiment, the leading-end protective layer surrounding a portion of the element base in which the temperature becomes high when the gas sensor is in use is provided to have a cross-sectional radius of curvature of 3 mm or less in the leading end portion thereof to secure good water resistance of the portion.

<Process of Manufacturing Sensor Element>

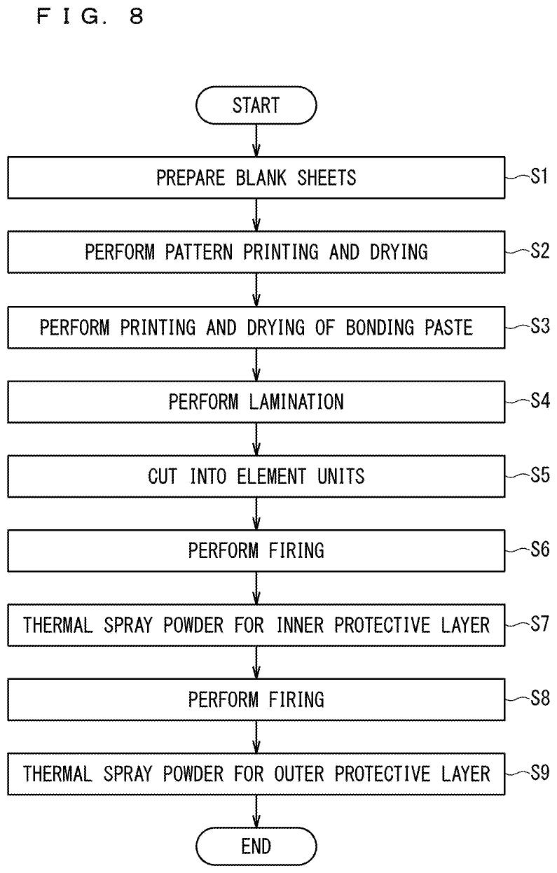

One example of a process of manufacturing the sensor element 10 having a configuration and features as described above will be described next. FIG. 8 is a flowchart of processing at the manufacture of the sensor element 10 by taking, as an example, a case where the leading-end protective layer 2 includes the inner leading-end protective layer 2a and the outer leading-end protective layer 2b in the manner illustrated in FIG. 7.

At the manufacture of the element base 1, a plurality of blank sheets (not illustrated) being green sheets containing the oxygen-ion conductive solid electrolyte, such as zirconia, as a ceramic component and having no pattern formed thereon are prepared first (step S1).

The blank sheets have a plurality of sheet holes used for positioning in printing and lamination. The sheet holes are formed to the blank sheets in advance prior to pattern formation through, for example, punching by a punching machine. Green sheets corresponding to a portion of the ceramic body 101 in which an internal space is formed also include penetrating portions corresponding to the internal space formed in advance through, for example, punching as described above. The blank sheets are not required to have the same thickness, and may have different thicknesses in accordance with corresponding portions of the element base 1 eventually formed.

After preparation of the blank sheets corresponding to the respective layers, pattern printing and drying are performed on the individual blank sheets (step S2). Specifically, a pattern of various electrodes, a pattern of the heater 150 and the insulating layer 151, a pattern of the electrode terminals 160, a pattern of the main-surface protective layers 170, a pattern of internal wiring, which is not illustrated, and the like are formed. Application or placement of a sublimable material (vanishing material) for forming the first diffusion control part 110, the second diffusion control part 120, the third diffusion control part 130, and the fourth diffusion control part 140 is also performed at the time of pattern printing. In a case where an underlying layer is formed, a pattern to form the underlying layer is printed onto blank sheets to become an uppermost layer and a lowermost layer after lamination.

The patterns are printed by applying pastes for pattern formation prepared in accordance with the properties required for respective formation targets onto the blank sheets using known screen printing technology. A known drying means can be used for drying after printing.

After pattern printing on each of the blank sheets, printing and drying of a bonding paste are performed to laminate and bond the green sheets (step S3). The known screen printing technology can be used for printing of the bonding paste, and the known drying means can be used for drying after printing.

The green sheets to which an adhesive has been applied are then stacked in a predetermined order, and the stacked green sheets are crimped under predetermined temperature and pressure conditions to thereby form a laminated body (step S4). Specifically, crimping is performed by stacking and holding the green sheets as a target of lamination on a predetermined lamination jig, which is not illustrated, while positioning the green sheets at the sheet holes, and then heating and pressurizing the green sheets together with the lamination jig using a lamination machine, such as a known hydraulic pressing machine. The pressure, temperature, and time for heating and pressurizing depend on a lamination machine to be used, and these conditions may be determined appropriately to achieve good lamination. The pattern to form the underlying layer may be formed on the laminated body obtained in this manner.

After the laminated body is obtained as described above, the laminated body is cut out at a plurality of locations to obtain unit bodies eventually becoming the individual element bases 1 (step S5).

The unit bodies as obtained are then each fired at a firing temperature of approximately 1300° C. to 1500° C. (step S6). The element base 1 is thereby manufactured. That is to say, the element base 1 is generated by integrally firing the ceramic body 101 made of the solid electrolyte, the electrodes, and the main-surface protective layers 170. Integral firing is performed in this manner, so that the electrodes each have sufficient adhesion strength in the element base 1.

After the element base 1 is manufactured in the above-mentioned manner, the inner leading-end protective layer 2a and the outer leading-end protective layer 2b are formed with respect to the element base 1. The inner leading-end protective layer 2a is formed by thermal spraying powder (alumina powder) for forming the inner leading-end protective layer prepared in advance at a location of the element base 1 as a target of formation of the inner leading-end protective layer 2a to have an intended thickness (step S7), and then firing the element base 1 on which an applied film has been formed in the above manner (step S8). The alumina powder for forming the inner leading-end protective layer contains alumina powder having predetermined particle size distribution and a pore-forming material at a ratio corresponding to a desired porosity, and the pore-forming material is pyrolyzed by firing of the element base 1 after thermal spraying to suitably form the inner leading-end protective layer 2a having a great porosity of 30% to 80%. Known technology is applicable to thermal spraying and firing.

The inner leading-end protective layer 2a can be caused to have the curved outermost surface on the side of the leading end surface 101e as illustrated in FIG. 7 by adjusting the speed of thermal spraying and an angle of the element base 1 at thermal spraying as appropriate.

Upon formation of the inner leading-end protective layer 2a, powder (alumina powder) for forming the outer leading-end protective layer similarly prepared in advance and containing alumina powder having predetermined particle size distribution is thermal sprayed at a location of the element base 1 as a target of formation of the outer leading-end protective layer 2b to have an intended thickness (step S9) to thereby form the outer leading-end protective layer 2b having a desired porosity. The alumina powder for forming the outer leading-end protective layer does not contain the pore-forming material. Known technology is also applicable to the thermal spraying. Measures to be taken in a case where the outer leading-end protective layer 2b is caused to have different thicknesses on the side of the pump surface 1p, on the side of the heater surface 1h, and on the side of the leading end surface 101e are similar to those taken at formation of the inner leading-end protective layer 2a.

In a case illustrated in FIG. 7, the outer leading-end protective layer 2b is formed to have substantially the same thickness on the inner leading-end protective layer 2a having the curved outermost surface (arcuate cross-sectional curve), so that the outer peripheral surface 2s of the leading-end protective layer 2 has an arcuate cross-sectional curve in the leading end portion 2e. In this case, the outer leading-end protective layer 2b is uniformly formed.

On the other hand, there is a case where the outermost surface of the inner leading-end protective layer 2a is not curved, and only the outermost surface of the outer leading-end protective layer 2b is provided to have the arcuate cross-sectional curve as described above. The leading end portion 2e of the leading-end protective layer 2 can be caused to have such a configuration also by adjusting the speed of thermal spraying and the angle of the element base 1 at thermal spraying as appropriate when the outer leading-end protective layer 2b is formed.

In a case where the leading-end protective layer 2 is provided as a single layer as illustrated in FIGS. 2 to 6, the above-mentioned step S9 is unnecessary.

The sensor element 10 is obtained by the above-mentioned procedures. The sensor element 10 thus obtained is housed in a predetermined housing, and built into the body (not illustrated) of the gas sensor 100.

<Modifications>

The above-mentioned embodiment is targeted at a sensor element having three internal chambers, but the sensor element is not necessarily required to have a three-chamber structure. That is to say, the sensor element may have one internal chamber or two internal chambers.

### Example

Nine types of sensor elements 10 having different combinations of the number of layers (a single layer or two layers), the thickness, the porosity, and the cross-sectional radius of curvature of the leading end portion 2e of the leading-end protective layer 2 were manufactured, and water resistance of the leading end portion 2e of each of the sensor elements 10 was evaluated. The leading-end protective layer 2 was provided to have the maximum thickness in the vicinity of the middle portion in the direction of the thickness of the element.

Water resistance was evaluated by specifying a critical water amount when a water droplet of 0.1 μL at a time is applied to the side of the one end portion E1 of the sensor element 10 while the pump current Ip0 is measured through the main pump cell P1 in a state of each of the sensor elements 10 being heated by the heater 150 to approximately 500° C. to 900° C.

The maximum thickness of the leading end portion 2e of the leading-end protective layer 2, the thickness and the porosity of each of the inner leading-end protective layer 2a and the outer leading-end protective layer 2b at the portion having this maximum thickness, the thickness of the element base 1 (“ELEMENT THICKNESS” in Table 1), the cross-sectional radius of curvature of the leading end portion 2e, and the result of evaluation of water resistance of the leading end portion 2e of each of the sensor elements 10 are shown in Table 1 as a list. As for the sensor element 10 including the leading-end protective layer 2 as a single layer, the maximum thickness and the porosity of the leading-end protective layer 2 are respectively shown in “THICKNESS” and “POROSITY” of “OUTER LEADING-END PROTECTIVE LAYER”.

In this case, the maximum thickness of the leading end portion 2e, the thickness and the porosity of each layer, and the cross-sectional radius of curvature of each of the sensor elements 10 are obtained from a cross-sectional SEM image. The cross-sectional radius of curvature is specified by specifying points corresponding to the points A and B of FIG. 3 in the cross-sectional SEM image, specifying an intersection of an imaginary line passing through the middle in the direction of the thickness of the element with the surface of the leading end portion 2e, and then applying the equation (1) to the three points. For confirmation, in each of the sensor elements 10, the shape of the arc having the cross-sectional radius of curvature obtained in the manner matches an actual curved shape of the leading end portion 2e.

TABLE 1

| MAXI- | | | | | | | |
|---|---|---|---|---|---|---|---|
| MUM | | | | | | | |
| THICK- | INNER | | OUTER | | | | |
| NESS | LEADING-END | | LEADING-END | | | CROSS- | |
| OF | PROTECTIVE | | PROTECTIVE | | | SECTIONAL | |
| LEADING | LAYER | | LAYER | | ELEMENT | RADIUS OF | WATER |
| END | THICK- | PORO- | THICK- | PORO- | THICK- | CURVATURE OF | RESISTANCE OF |
| PORTION | NESS | SITY | NESS | SITY | NESS | LEADING END | LEADING END |
| [μm] | [μm] | [%] | [μm] | [%] | [mm] | PORTION [mm] | PORTION [μL] |
| 300.0 | — | — | 300.0 | 25.0 | 1.5 | 4.4 | 6.8 |
| 800.0 | 600.0 | 60.0 | 200.0 | 25.0 | 1.5 | 2.6 | 20.0 |
| 473.5 | 342.9 | 72.3 | 130.6 | 18.4 | 1.6 | 4.3 | 7.0 |
| 565.0 | 395.0 | 34.8 | 170.0 | 23.4 | 1.5 | 1.9 | 34.3 |
| 508.0 | 232.0 | 40.7 | 276.0 | 16.2 | 1.0 | 0.9 | 38.8 |
| 354.2 | — | — | 354.2 | 15.0 | 1.45 | 3.5 | 8.3 |
| 372.9 | 216.4 | 50.0 | 156.5 | 25.0 | 1.45 | 3.8 | 8.4 |
| 634.5 | 416.3 | 62.5 | 218.2 | 25.0 | 1.45 | 2.9 | 15.3 |
| 881.8 | 684.0 | 67.2 | 197.8 | 21.3 | 1.45 | 2.1 | 26.7 |

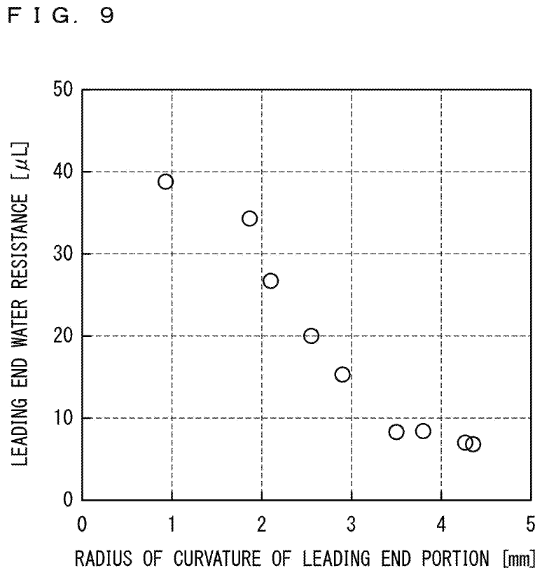

FIG. 9 is a plot of a value of water resistance of the leading end portion 2e shown in Table 1 against the radius of curvature of the leading end portion 2e.

It is confirmed from Table 1 and FIG. 9 that the value of the leading end water resistance exceeds 10 μL in a case where the cross-sectional radius of curvature of the leading end portion is 3 mm or less regardless of a difference in specific configuration of the leading end portion 2e.

In particular, it is confirmed that the value of the leading end water resistance exceeds 30 μL in a case where the leading-end protective layer 2 has the two-layer configuration, and the cross-sectional radius of curvature of the leading end portion is 2 mm or less.

The above-mentioned results indicate that reduction in cross-sectional radius of curvature of the leading end portion of the leading-end protective layer of the sensor element is effective in improving water resistance of the leading end portion of the leading-end protective layer.

While the invention has been shown and described in detail, the foregoing description is in all aspects illustrative and not restrictive. It is therefore understood that numerous modifications and variations can be devised without departing from the scope of the invention.

What is claimed is:

1. A sensor element for a gas sensor, said sensor element comprising:
an element base being a ceramic structure, said element base including a sensing part for sensing a gas component to be measured and a heater for heating said sensor element; and
a leading-end protective layer disposed around an outer periphery of said element base in a predetermined range at least including a leading end surface, and being a porous layer including one or more unit layers, wherein
a radius of curvature of said leading-end protective layer on a side of said leading end surface in vertical cross section along a longitudinal direction of said sensor element is greater than ½ of thickness of said element base and is 3 mm or less.

2. The sensor element according to claim 1, wherein
said element base has a thickness of 1 mm or more and 1.5 mm or less, and
said radius of curvature is 0.5 mm or more and 2 mm or less.

3. The sensor element according to claim 1, wherein
a portion of said leading-end protective layer to be an outer peripheral surface thereof has a porosity of 15% or more and 30% or less.

4. The sensor element according to claim 3, wherein
said leading-end protective layer includes two layers, an inner leading-end protective layer and an outer leading-end protective layer,
said inner leading-end protective layer has a porosity of 30% or more and 80% or less, and
said outer leading-end protective layer has a porosity of 15% or more and 30% or less.

5. The sensor element according to claim 1, wherein
a maximum thickness of said leading-end protective layer on said side of said leading end surface is 400 μm or more and 800 μm or less.

6. The sensor element according to claim 2, wherein
a portion of said leading-end protective layer to be an outer peripheral surface thereof has a porosity of 15% or more and 30% or less.

7. The sensor element according to claim 6, wherein
said leading-end protective layer includes two layers, an inner leading-end protective layer and an outer leading-end protective layer,
said inner leading-end protective layer has a porosity of 30% or more and 80% or less, and
said outer leading-end protective layer has a porosity of 15% or more and 30% or less.

8. The sensor element according to claim 2, wherein
a maximum thickness of said leading-end protective layer on said side of said leading end surface is 400 μm or more and 800 μm or less.

9. The sensor element according to claim 3, wherein
a maximum thickness of said leading-end protective layer on said side of said leading end surface is 400 μm or more and 800 μm or less.

10. The sensor element according to claim 4, wherein
a maximum thickness of said leading-end protective layer on said side of said leading end surface is 400 μm or more and 800 μm or less.

11. The sensor element according to claim 6, wherein
a maximum thickness of said leading-end protective layer on said side of said leading end surface is 400 μm or more and 800 μm or less.

12. The sensor element according to claim 7, wherein
a maximum thickness of said leading-end protective layer on said side of said leading end surface is 400 μm or more and 800 μm or less.
